(19) United States
(12) Patent Application Publication
(10) Pub. No.: US 2012/0053723 A1
(43) Pub. Date: Mar. 1, 2012

(54) Method of Controlling a Process and Process Control System

(76) Inventor: Matthias Richter, Dresden (DE)

(21) Appl. No.: 12/871,348

(22) Filed: Aug. 30, 2010

(51) Int. Cl. G06F 17/00; G06K 9/00

(52) U.S. Cl. 700/110; 382/149

(57) ABSTRACT

A system and a method for controlling a semiconductor manufacturing process are disclosed. The method comprises providing a plurality of structured wafers and taking a series of images from the plurality of structured wafers, wherein one image is taken for each structured wafer and wherein the image is taken of a same location for each structured wafer. The method further comprises extracting information of a parameter for each of the series of images and comparing the extracted information.

### TECHNICAL FIELD

The present invention relates generally to a semiconductor fabrication process. In particular, embodiments relate to a process control method and a process control system.

### BACKGROUND

Semiconductor devices are typically fabricated by sequentially depositing insulating or dielectric layers, conductive layers, and semiconductive layers of material over a semiconductor substrate, and patterning the various layers using lithography to form circuit components and elements thereon.

Semiconductor manufacturing steps may be tested using a variety of test processes and procedures at many stages of the semiconductor manufacturing process. An e-beam defect density inspection device is designed to detect randomly distributed defects on one structured wafer.

The current e-beam defect density inspection devices are capable of providing information regarding defects based on three algorithms: Cell-to-cell comparison, die-to-die comparison or die-to-golden die comparison. E-Beam defect density inspection devices detect defects within the same wafer by those algorithms.

### SUMMARY OF THE INVENTION

In accordance with an embodiment of the present invention, a method comprises providing a plurality of structured wafers and taking a series of images from the plurality of structured wafers, wherein one image is taken for each structured wafer and wherein the image is taken of a same location for each structured wafer. The method further comprises extracting information of a parameter for each of the series of images and comparing the extracted information.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a flow chart of a process control method;

FIG. 2 shows a wafer;

FIG. 3 shows an enlargement of the wafer;

FIG. 4 shows an image of a location on the wafer;

FIG. 5 shows a series of images from one location of a plurality of wafers;

FIG. 6 shows exemplary parameters of a histogram;

FIG. 7 shows a histogram of the image of the location on the wafer;

FIG. 8 shows a trending chart; and

FIG. 9 shows a process control system.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to embodiments in a specific context, namely a process control method or a layer process control method and a process control system or a layer monitoring system.

In one embodiment the process control method may measure a location or a feature on the wafer. The location or the feature may be indirectly measured, e.g., by taking an image and measuring parameters from the image. In one embodiment the process control method may measure electrical or physical parameters of a feature or a location in or on a layer in a die. The measurement of the electrical or physical parameters may provide qualitative information about the feature or location in or on the layer in the die.

In one embodiment the process control method may measure electrical defects of a location and a layer on a die. The method may provide detailed and exact information of the quality of the electrical defect. In one embodiment the process control method may measure physical defects of a location and a layer on a die and may provide detailed and exact information of the quality of the physical defect.

The process control method may monitor process variations between different lots of wafers and/or different wafers and may track extracted data in trending charts. For example, if etching processes for some wafers were faulty, trench contacts will not be correctly contacted to underlying contacts and the extracted data may show deviations from normal conditions in trending charts.

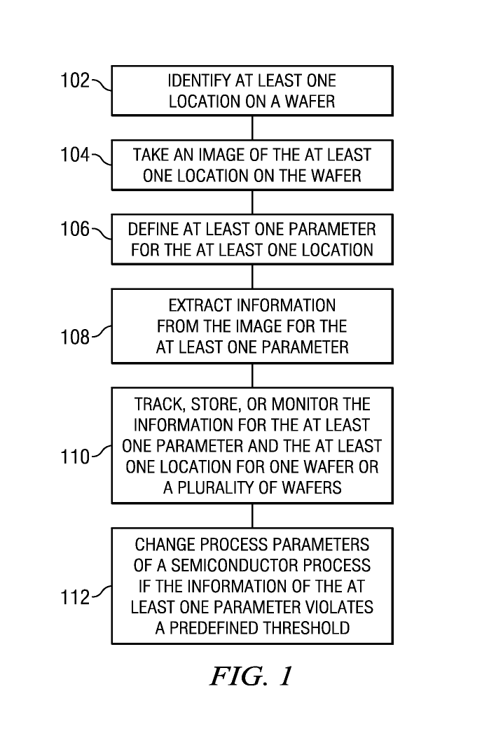

FIG. 1 shows a flow chart of a process control method of a semiconductor manufacturing process. The process control method may be a layer monitoring method. The process control method may monitor parameters of a location on a wafer.

In block 102 at least one location on a semiconductor wafer is identified. In block 104 an image is taken of the at least one location on the wafer. In block 106 at least one parameter is defined for the at least one location. In block 108 information is extracted for the at least one parameter from the image. In block 110 the extracted information for the at least one parameter of the at least one location is stored, tracked or displayed for one wafer or a plurality of wafers. In block 112 process parameters or receipts of an underlying semiconductor manufacturing process are changed if the displayed, stored or tracked information of at least one parameter violates a predefined threshold. The blocks 102-112 may be performed in order as steps 102-112. The steps 102-112 may also be performed in a different order. For example, step 106 could be performed before step 102.

In the following paragraphs the flow chart of FIG. 1 is discussed in detail. Each block 102-112 is revisited in turn.

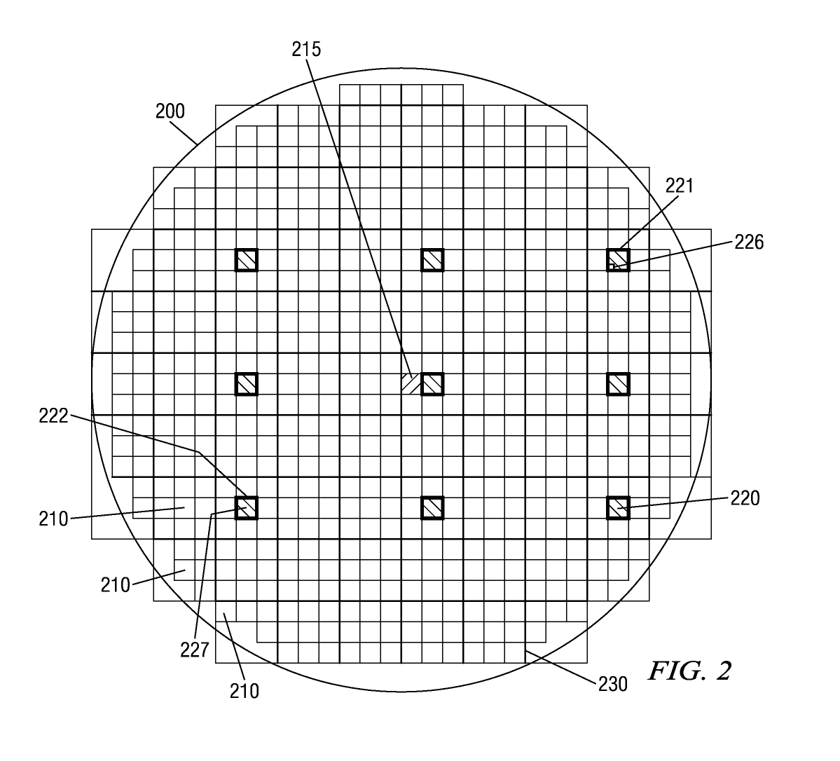

In a first step at least one location on the wafer is identified (block 102). FIG. 2 shows a wafer 200 having a plurality of dies 210 located on the wafer. The dies 210 are separated by kerfs 230. The dies 210 may be enabled or disabled for inspection. An enabled die 210 is a selected die 220. FIG. 2 shows 9 selected dies 220. Alternatively, only 1, 2 or any reasonable number of selected dies 220 may be enabled on the wafer 200. FIG. 2 further shows a specific location or position 226 for an enabled die 221 and a specific location or position 227 for an enabled die 222. In one embodiment not only dies 210 can be enabled or disabled but also locations in the kerf.

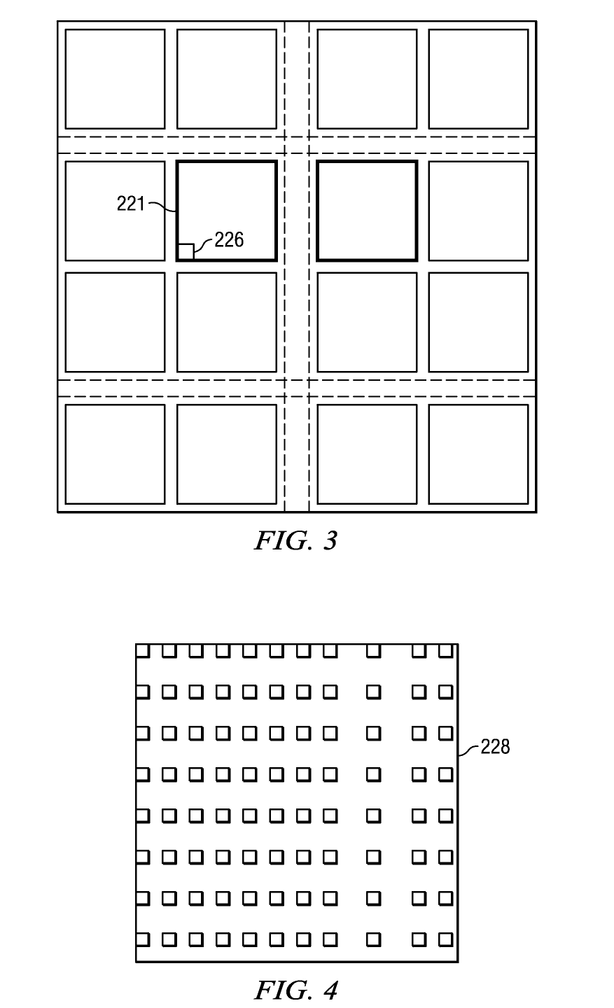

FIG. 3 shows a detail of the location or position 226 of the enabled die 221. The specific location or position 226 may be predefined or defined by a user. For example, referring again to FIG. 2, a first location 226 may be defined for the selected die 221 and a second location 227 may be defined for the selected die 222. The first location 226 of selected die 221 and the second location 227 of selected chip 222 may be a same location or a different location on a same type of die. The first location 226 of selected die 221 and the second location 227 of selected die 222 may be a different location on a different type of die. Alternatively, the specific location or position 226 may be defined for the kerf 230.

The specific location or position 226 may be a spot coordinate. The spot coordinate may be a specific point having an x coordinate and a y coordinate. In one embodiment the spot coordinate may be an area defined by x+Δx and y+Δy. In one embodiment the spot coordinate may be a larger area. In one embodiment the spot coordinate is a structure. In one embodiment the location or position 226 is a feature such as a semiconductor device, a transistor, a capacitor, a resistor, a MEMS or memory device such as a flash memory device. In one embodiment the spot coordinate is an active area, a shallow trench, a deep trench, or a gate.

The specific location or position 226 may be for an etched trench, a patterned layer, a via, or a conductive line. Alternatively, the specific location or position 226 may be for a doped area, a contact or any other feature in or on the layer. The specific location 226 may be an array of etched trenches, contacts, etc. In one embodiment the specific location or position 226 is selected for only one step in a semiconductor manufacturing process. For example, the specific location or position 226 may be chosen for a contact. In one embodiment the specific location or position 226 may be chosen for a series of steps in a semiconductor manufacturing process. For example, the specific location or position 226 may be chosen for an etched contact hole and a filled contact hole, e.g., a contact.

According to block 104 an image is taken for at least one location on the wafer 200. The image may be taken of the location or position 226. The location or position 226 may be on a chip or in the kerf.

The image may be taken by an inspection device. The inspection device may take voltage contrast images. The inspection device may take scanning electron microscope (SEM) type images. The inspection device may take images having different levels of grey on a grayscale. The inspection device may take images wherein each pixel in the image has a level of grey. The level of grey may be a continuous between 0 for very dark pixels and 255 for very light pixels for an 8 bit resolution. For example, dark pixels may be assigned a grey level between 20 and 50 and light pixels may be assigned a grey level between 205 and 235. Alternatively, the image may be taken by an e-beam inspection device or by a SEM type inspection device.

The image may be taken for a specific production step in a semiconductor manufacturing process manufacturing the dies 210 on the wafer 200. For example, an image is taken of a specific location or position for an etched trench, a patterned layer, a via, a conductive line or arrays thereof. Alternatively, an image is taken of the specific location or position for a doped area, a contact or any other feature. In one embodiment an image is taken for only one step in a semiconductor manufacturing process for the specific location or position. For example, an image is taken of a contact. In one embodiment an image is taken of each of a series of steps in a semiconductor manufacturing process for the specific location or position. For example, one image is taken of an etched contact hole and one image is taken of a filled contact hole, e.g., a contact.

FIG. 4 shows an example of an image 228 taken of the specific location or position 226 of selected chip 221 on the wafer 200. The image 228 may reflect a structure of a feature of the location 226 of chip 221. For example, the image 228 may show an array of contacts. The white areas in image 228 may be tungsten (W) contacts. As discussed in more detail below, images taken of a plurality of wafers for the same location should match or should substantially match for a selected step in the semiconductor manufacturing process. For example, the image in FIG. 4 showing an array of contacts should be the same or should be substantially the same for a first wafer and a second wafer when the process conditions have not changed. Similarly, images taken of a plurality of same locations for the same type of dies within one wafer should match or should substantially match for a selected step in the semiconductor manufacturing process. For example, the image for location 226 of die 221 and the image of location 227 of die 222 in FIG. 2 should be the same or should be substantially the same if the dies 221, 222 are the same type of die and the locations 226, 227 are the same location or the same feature.

Referring again to FIG. 2, an image may be taken not only for locations 226, 227 of dies 221, 222 but also for any of the 9 enabled dies 220 of the wafer 200. The location 226 may be a different location or a same location as location 227. The images for location 226 and 227 maybe taken in a separate imaging process.

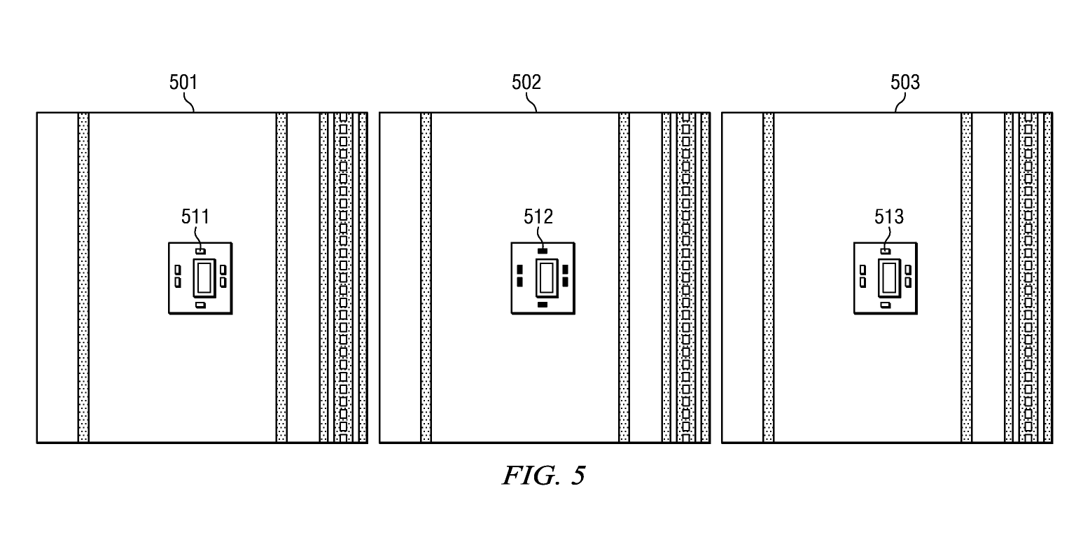

FIG. 5 shows an exemplary embodiment of three images 501-503 taken of the same location 226 on three different wafers. The three images 501-503 show deep trench contacts 511-513. As can be seen from the different grey levels of images 501-503, deep trench contact 511 and deep trench contact 513 are completely etched through while the deep trench contact 512 of image 502 is not completely etched through. The image 502 of deep trench contact 512 has a darker grey level than the images 501, 503 of deep trench contacts 511 and 513. Generally, the darker the grey level is the worse the quality of the deep trench contact.

Referring now to block 106, at least one parameter for at least one location is defined. In one embodiment the parameter may be an electrical parameter. The electrical parameter may provide information of the quality of the location 226. The electrical parameter may provide information of the quality of location 226 based on a voltage contrast. In some applications only one parameter may be defined. In other applications a plurality of parameters may be defined.

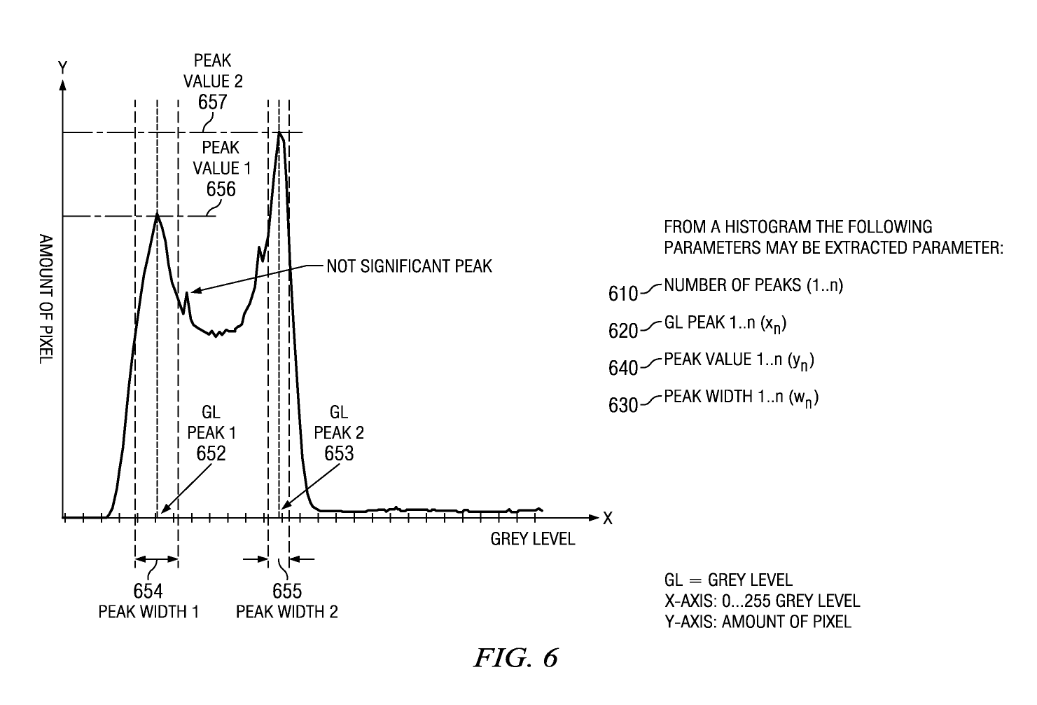

FIG. 6 shows an exemplary selection of possible parameters for a histogram 600. For example, valuable parameters may be “Number of peaks (1 . . . n)” 610 in the histogram 600, “Grey Level (GL) of the Grey Level Peak 1, . . . , n (xₙ)” 620, “Peak Width 1, . . . , n (wₙ)” 630 and “Peak Value of Peak 1, . . . . n (yₙ)” 640. Accordingly, information which may be generated from the histogram 600 for the parameters is as follows: Number of peaks (610): 2, since the small peak is a non-significant peak; GL Peak 1 (x₁)(620): 652; GL Peak 2 (x₂)(620): 653; Peak Width 1 (w₁)(630): 654; Peak Width 2 (w₂)(630): 655; Peak Value for Peak 1 (y₁)(640): 656; Peak Value for Peak 2 (y₂)(640): 657.

Next, block 108 shows that information regarding at least one parameter for each image is extracted. In one embodiment a histogram is extracted from the image. The histogram may be processed with a simple algorithm. For example, each pixel of the image may have a grey level. The grey levels of all pixels are measured and are arranged in a diagram wherein the x axis shows the grey level from 0 to 255 and wherein the y axis shows the amount of pixels. The amount of pixels for a specific grey level may be the number of pixels in the image 228 having this specific grey level.

In one embodiment the histogram may be processed with a more complex algorithm. For example, the more complex algorithm not only takes into account the simple algorithm described above but also calculations scaling separate areas in the image differently and/or weighting separate areas in the image differently.

Every location or position on the wafer 200 may comprise a unique histogram. Imaging the same location on a wafer over a series of different wafers may produce the same or substantially the same histograms for each wafer in a stable process. Imaging the same location on a wafer over a series of different wafers may produce different histograms for each wafer if the process is not stable or if the process parameters of the semiconductor manufacturing process have been intentionally changed. For example, referring again to FIG. 5, the grey level peak for “good” contacts 511, 513 may be 230 and the grey level peak for “bad” contact 512 may be 180. Accordingly, histograms for contacts 511, 513 are different than the histogram for contact 512. The measured grey level peaks 511-513 may show levels of resistance of contacts 511-513 when a voltage is applied to the die. For example, grey level peak 230 may reflect a resistance of about 5Ω in “good” contacts 511, 513 and grey level peak 230 may reflect a resistance of about 350Ω in a “bad” contact 512.

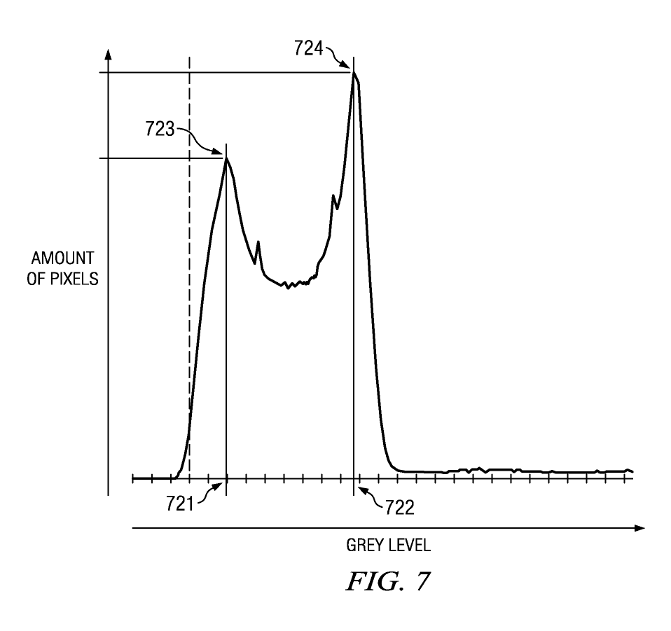

FIG. 7 shows a histogram 700 extracted from the image 228 in FIG. 4. The image 228 is extracted from the first location 226 of the first enabled die 221. The histogram 700 shows a unique structure for the location 226 of die 221. The histogram 700 shows grey levels along the x-axis and an amount of pixels along the y-axis. Histogram 700 shows a first grey level peak 721 and a second grey level peak 722. Histogram 700 shows a first peak value 723 and second peak value 724. The first grey level peak 721 may be identified as a background grey level peak (darker) while the second grey level peak 722 may be identified as a tungsten (W) plug grey level peak (lighter).

Of course, since the histograms for each location 226, 227 are unique the displayed histograms are just examples. In fact the histogram may have any form or structure.

Information regarding a selected parameter or a plurality of selected parameters may be extracted from the histograms. In this particular example three parameters may be selected for the first location 226 of die 221. Information read from the histogram 700 may be: “Number of Peaks:” 2; “GL Peak 1:” grey level 721; and “GL Peak 2:” grey level 722. The information of each parameter may be stored in a separate file or in a same file or may be displayed on a monitor or on separate monitors.

Instead of three parameters, five parameters may be selected and information may be extracted from the image for these five parameters. For example, additional parameters may be “Peak value 1” 723 and “peak value 2” 724. Alternatively only one parameter can be chosen. The one parameter may be any of the listed parameters.

Referring now to block 110, the information for the at least one parameter and the least one location for a plurality of wafers may be stored, tracked or displayed.

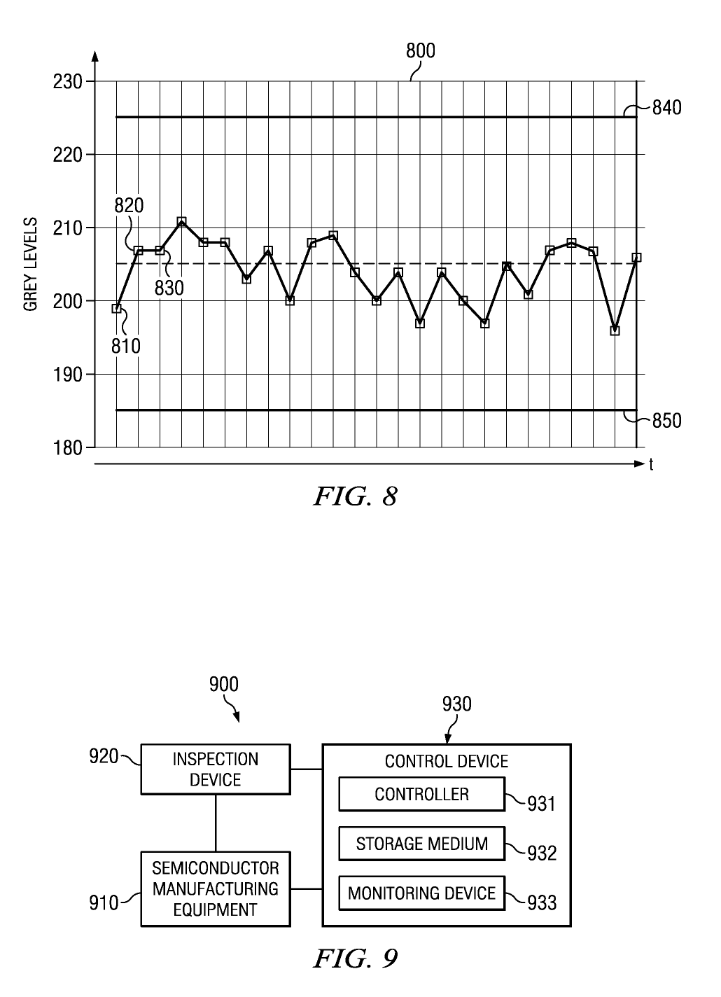

In one embodiment the information from the wafers can be tracked in a trending chart. Each parameter for one location may be tracked in a separate trending chart. For example, FIG. 8 shows a trending chart 800 for the selected parameter “GL Peak 2” 620 of location 226 of die 221. The grey levels for the parameter “GL Peak 2” for a specific layer and a plurality of wafers are shown over time t. The grey level plot 810 is extracted from a first wafer. The grey level for the first wafer is 189. The grey level plot 820 is extracted from a second wafer. The grey level for the second wafer is 207. The grey level plot 830 is extracted from a third wafer. The grey level for the third wafer is 207, etc. As can be seen from FIG. 8 the grey level plots of the parameter “GL Peak 2” vary over time roughly between grey level 200 and grey level 210. In a stable process the selected parameters should generally be varying within a predefined range for a plurality of wafers. The underlying semiconductor manufacturing process step for these grey level plots may be considered a stable process because it varies between the thresholds 185 and 225.

In one embodiment the trending chart may be for a plurality of locations. The grey levels for a specific parameter and a specific layer may be shown over the location. For example, similar to FIG. 8, the y axis may show grey levels and the x axis may show the locations for the different dies of one wafer.

In one embodiment each wafer may be inspected. However, in some embodiments only one wafer per lot may be inspected. Accordingly, the first wafer for plot 810 is from a first lot, the second wafer for plot 820 is from a second lot and the third wafer for plot 830 is from a third lot. Alternatively, the number of wafers of a plurality of wafers (selected ratio) to be inspected may depend on efficiency/cost evaluations.

The information of an inspected wafer may be stored or tracked by assigning the wafer a Lot ID, a Wafer ID, a date and a time to each plot. The information of a plurality of wafers may be stored or tracked in a trending chart data. The trending chart data may be excel importable log file data. Alternatively, the trending chart data may be charts or box plots.

In block 112 of FIG. 1 the monitored manufacturing process is adjusted or halted if the tracked information for at least one parameter reaches a limited or predefined threshold.

FIG. 9 shows a process control system 900. The process control system 900 may comprise a semiconductor manufacturing equipment 910, an inspection device 920 and a control device 930. The semiconductor manufacturing equipment 910 may be a lithography system, an etching apparatus, a film deposition device or a mechanical polishing apparatus. Alternatively, the semiconductor manufacturing equipment 910 may be any other device used to carry out a semiconductor manufacturing process step. The semiconductor manufacturing equipment 910 may be a plurality of semiconductor equipments. For example, the semiconductor equipment 910 may be a film deposition device, a lithography system and an etching apparatus.

In one embodiment the inspection device 920 may be an e-beam inspection device. In another embodiment the inspection device 920 may be a scanning electron microscope (SEM) type inspection device or a SEM review device. In yet another embodiment the inspection device 920 may be an inspection device taking images based on voltage contrast.

The inspection device 920 may comprise different (software) applications. The inspection device 920 may be able to run a Trending Application or Layer Monitoring Application in addition to a Scan Application or a Review Application. The Trending Application may provide information necessary to perform an inspection in the inspection device 920. For example, the Trending Application may provide the location on the wafer for a layer of where to take an image. The Trending Application may also include the selected parameters to be measured. The selected parameters may have been predefined by a user. The Trending Application may further provide the format in which the extracted data may be processed or forwarded to the control device 930. The Trending Application may be individually defined for each layer or each feature to be inspected. The Trending Application may enable the inspection device 920 to perform all the inspection steps to extract the information to be monitored.

The control device 930 may be a Yield Management System (YMS). The control device 930 may be a Statistical Process Control (SPC). The control device 930 may be a Yield Management System (YMS) and a Statistical Process Control (SPC).

The information extracted for one location may be forwarded from the inspection device 920 to the control device 930. The information forwarded may be in a KLA-Tencor File Format (KLARF®) when the control device 930 is the Yield Management System. The information forwarded may be forwarded via the SEMI Equipment Communication Standard (SECS) interface to the Statistical Process Control (SPC). The data provided to the SPC may comprise the following format:

| Format | Description |
|---|---|
| Inspection ID | Product and layer information |
| Position (Die x, y; Chip x, y) | Location |
| Selected parameters | Defined by User |

Die x,y may be the selected die 221 relative to reference point 215. Chip x,y may be the location 226 within the die 221. Selected parameters for die location 225/die 221 may be Number of Peaks: 2; GL Peak 1: 722; GL Peak 2: 723.

The control device 930 may comprise a controller 931, a storage medium 932 and a monitoring device 933. The controller 931 of the control device 930 may collect information from the inspection device 920 and may store it in a removable or non-removable storage medium 932. The stored data may be the information of the inspected wafer for each parameter, the Lot ID, the Wafer ID, the date and a time. The data may be stored in a trending chart. The monitoring device 933 may display the stored information or the trending chart. The monitoring device 933 may monitor the trending chart. If the trend in the trending chart moves in an undesired direction or violates a threshold value, the monitoring device 933 may issue an alarm on a display or may issue an alarm to the controller 931 which in turn may send a signal to adjust or shut down the semiconductor manufacturing equipment 910.

In one particular example, the monitoring device 933 may monitor the trending chart 800 of FIG. 8. A range is defined by an upper boundary 840 (upper grey level) and a lower boundary 850 (lower grey level). The defined range may be a preferable or allowable range for “GL Peak 2.” The grey level of the upper boundary 840 is 225 and the grey level of the lower boundary 850 is 185. None of the grey level plots of 810-830 is lying outside the predefined range of upper and the lower boundaries. Of course, the range maybe defined narrower or wider depending on the respective step of the underlying semiconductor manufacturing process. The ranges may be defined by quality and yield of the die or chip based on the semiconductor manufacturing process.

In one embodiment the monitoring device 933 may issue an alarm signal in case the trend in the trending chart 800 meets or overshoots the upper boundary 840 or the lower boundary 850. The semiconductor manufacturing process maybe considered stable within the predefined boundaries 840, 850 of the trending chart 800. In one embodiment the controller 931 may issue a shut down or a boundary violation signal so that the semiconductor manufacturing equipment 910 may shut down or adjust the recipe or process parameters of the current semiconductor manufacturing step.

In one embodiment the upper boundary 840 comprises two upper grey level limits and the lower boundary 850 comprises two lower grey level limits may be defined. The first upper grey level limit, which is lower than the second upper grey level limit may initiate an alarm and the second upper grey level limit may shut down the system. Similarly, the first lower grey level limit, which is higher than the second lower grey level limit, may initiate an alarm and the second lower grey level limit may shut down the system.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for controlling a semiconductor manufacturing process, the method comprising:
taking a series of images of a plurality of structured wafers, wherein one image is taken for each structured wafer, and wherein the image is taken of a same location for each structured wafer;
extracting information of a parameter for each for the series of images; and
monitoring the extracted information.

2. The method according to claim 1, wherein the location is located on a die.

3. The method according to claim 1, further comprising storing the extracted information as data in a storage medium.

4. The method according to claim 1, wherein the image is taken of the same location comprises taking an image of a plurality of same locations.

5. The method according to claim 1, wherein the parameter comprises a plurality of parameters.

6. The method according to claim 5, after taking a series of images, further comprises generating a histogram for each of the images.

7. The method according to claim 6, wherein the parameter comprises at least one of number of peaks in the histogram, grey level of at least one peak in the histogram, peak width of at least one peak in the histogram, or at least one peak value in the histogram.

8. The method according to claim 1, further comprising adjusting or shutting down the semiconductor manufacturing process if the extracted information is outside a predefined range of the parameter.

9. The method according to claim 1, wherein the parameter is an electrical parameter.

10. The method according to claim 1, wherein the image is taken by an e-beam inspection device.

11. A system for monitoring a semiconductor manufacturing process, the system comprising:
a semiconductor manufacturing equipment configured to apply a process step to a plurality of wafers;
an inspection device, the inspection device configured to take an image of a location of each wafer after the process step has been applied, the inspection device taking the image for a same location of each of the plurality of wafers and configured to extract information for a parameter from the series of images; and
a control device, the control device configured to monitor the extracted information.

12. A system according to claim 11, wherein the control device is configured to issue a signal to the semiconductor manufacturing equipment to adjust receipts or process parameters of the semiconductor manufacturing process.

13. The system according to claim 12, wherein the control device issues the signal if the extracted and monitored information meets a predefined threshold value.

14. The system according to claim 11, wherein the control device is configured to issue a signal to shut down the semiconductor manufacturing equipment or to alarm an operator.

15. The system according to claim 11, wherein the inspection device is an e-beam inspection device.

16. The system according to claim 11, wherein the semiconductor manufacturing equipment is a plurality of semiconductor manufacturing equipments.

17. A method for controlling a semiconductor manufacturing process, the method comprising:
selecting a first die location on a first structured wafer;
taking a first image of the first die location;
extracting a first information for a parameter from the first image;
selecting a second die location on a second structured wafer, wherein the first die location comprises a same coordinate as the second die location;
taking a second image of the second die location;
extracting a second information for the parameter from the second image; and
comparing the first information and the second information.

18. The method according to claim 17, wherein the first structured wafer and the second structured wafer are processed with a same semiconductor manufacturing process step.

19. The method according to claim 17, wherein the first location on a first structured wafer and the second location on the second structured wafer comprises a deep trench.

20. The method according to claim 17, wherein the parameter is an electrical parameter.
